(19) United States
(12) Patent Application Publication
(10) Pub. No.: US 2026/0308324 A1
(43) Pub. Date: Oct. 8, 2026

(54) POLYIMIDES AND PROCESSES OF MAKING AND USING SAME

(71) Applicant: Government of the United States as represented by the Secretary of the Air Force, Wright-Patterson AFB, OH (US)

(72) Inventors: Zhenning Yu, Beavercreek, OH (US); Christopher A. Crouse, Waynesville, OH (US); Matthew L. Baczkowski, Dayton, OH (US)

(21) Appl. No.: 19/169,217

(22) Filed: Apr. 3, 2025

(51) Int. Cl. C08G 73/10

(52) U.S. Cl. CPC C08G 73/1007; C08G 73/1042; C08G 73/1078; C08G 73/1082

(57) ABSTRACT

Substituted fluorene moiety containing diamine monomers, polyimides comprising such diamine monomers and processes of making and using such diamine monomers and polyimides are disclosed. Such polyimides are fully imidized. Such polymers needed not be processed at high temperatures, yet they can survive high temperatures. Materials, such as coatings, that employ the disclosed polyimides can be applied at low temperatures using less-toxic solvents, yet such coatings can survive high temperatures. Such polyimides can be used in applications such as a resin for preparation of polymer matrix composite, a binder or adhesive for joint multiple components and a binder or a resin component for a coating. Furthermore, the such polyimide-based coating or composite can be used as a thermal insulation layer and/or electrical insulation layer for electronic packaging. Finally, as the disclosed polyimides are highly soluble, they can easily be recycled and/or reconfigured

### RIGHTS OF THE GOVERNMENT

The invention described herein may be manufactured and used by or for the Government of the United States for all governmental purposes without the payment of any royalty.

### FIELD OF THE INVENTION

The present invention relates to substituted fluorene moiety containing diamine monomers, polyimides comprising such diamine monomers and processes of making and using such diamine monomers and polyimides.

### BACKGROUND OF THE INVENTION

Protecting sensitive materials and electronic devices against thermal and/or electrostatic discharge damage while exposed or operating at elevated temperatures is increasingly important for aerospace and commercial applications. Current protective coatings must be applied at high temperatures to survive service temperatures of 200° C. or above. Current protective coatings employ a polymer having a high glass transition temperature, T_{g}, such as a polyimide. Traditionally, a polyimide coating, such as Kapton® enamels, is applied at the soluble polyamic acid stage. The solvents are typically non-aprotic organic solvents, such as dimethylacetamide (DMAc), 1-methyl-2-pyrrolidinone (NMP) or mixtures containing the said solvents. To achieve the final coating properties, the coating and the coated substrates must go through heating cycles for solvent removal and conversion of the polyamic acid to polyimide, which is known as the imidization. The imidization process limits the applications of such approach, as the substrates being protected must be able to survive the imidization process. The in-situ thermal imidization process is not suitable for coating of any heat sensitive objects including, but not limited to, nanoparticles, organic particulates, or heat sensitive electronics.

Applicants recognized that the source of the problems associated with the current polyimide materials that are used as coatings was that they were not fully imidized and lacked solution processability once imidized. Applicants also recognized by utilizing substituted fluorene moiety containing diamine monomers, it is possible to create a solution processable polyimide. Polyimides from such monomers provide enhanced solubility in low boiling point and/or less toxic solvents such as ethyl acetate and methyl ethyl ketone and as they are fully imidized. Polymers need not be processed at high temperatures, yet they can survive/remain functional at temperatures that are 270° C. to 370° C. Thus, Applicants disclose herein diamine monomers, polyimides comprising such diamine monomers and processes of making and using such diamine monomers and polyimides. The disclosed polyimides are fully imidized and comprise/are derived from substituted fluorene moiety containing diamine monomers. As a result, the disclosed polyimides can be applied at low temperatures using less-toxic solvents, yet such coatings can survive high temperatures. Such polyimides can be used in applications such as: a resin for preparation of polymer matrix composite, adhesive for joining multiple components and/or as a binder for coating. Furthermore, the such polyimide-based coating or composite can be used as a thermal insulation layer and/or electrical insulation layer for electronic packaging. Finally, as the disclosed polyimides are highly soluble, they can easily be recycled and/or reconfigured.

### SUMMARY OF THE INVENTION

Substituted fluorene moiety containing diamine monomers, polyimides comprising such diamine monomers and the processes of making and using such diamine monomers and polyimides are disclosed. Such polyimides are fully imidized. Such polymers needed not be processed at high temperatures, yet they can survive high temperatures. Materials, such as coating, that employ the disclosed polyimides can be applied at low temperatures using less-toxic solvents, yet such coatings can survive high temperatures. Such polyimides can be used in applications such as a resin for preparation of polymer matrix composites, a binder or adhesive for joining multiple components and a binder or a resin component for a coating. Furthermore, the polyimide-based coating or composite can be used as a thermal insulation layer and/or electrical insulation layer for electronic packaging. Finally, as the disclosed polyimides are highly soluble, they can easily be recycled and/or reconfigured.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

For purposes of this specification a fluorene moiety has the following structure

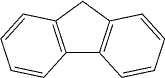 [SMILES: c1ccc2c(c1)Cc1ccccc1-2]

and an example of a substituted fluorene moiety containing diamine, 9,9-Bis(3-fluoro-4-aminophenyl) fluorene, CAS Registry Number: 127926-65-2, may have the following structure:

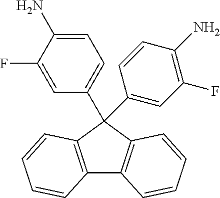 [SMILES: Nc1ccc(C2(c3ccc(N)c(F)c3)c3ccccc3-c3ccccc32)cc1F]

### Fluorene Containing Diamine Monomer and Process of Making and Using Same in Polymers as Well as Articles and Compositions Comprising Said Polymer

In this paragraph Applicants disclose a fluorene containing diamine monomer having one of the following structures:

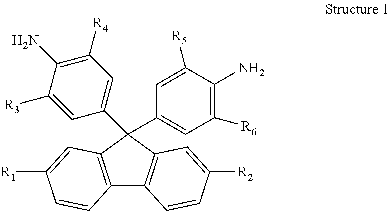

wherein for Structure 1, R₁, R₂, R₃, R₄, R₅ and R₆ are each independently H, CH₃, CF₃, F, Cl or Br, with the proviso that at least one of R₃, R₄, R₅, R₆ are not identical, preferably at least one of R₃, R₄, R₅, R₆ is CH₃, CF₃, F; more preferably at least one of R₃, R₄, R₅, R₆ is CF₃ or F;

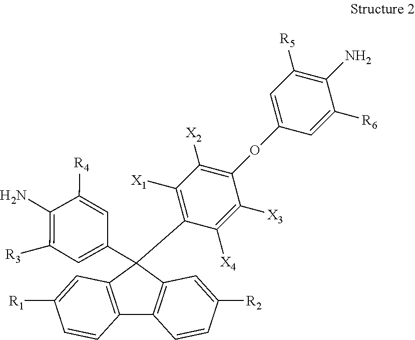

wherein for Structure 2: R₁, R₂, R₃, R₄, R₅, R₆, X₁, X₂, X₃, and X₄ are each independently H, CH₃, CF₃, F, Cl or Br, with the proviso that at least one of R₃, R₄, R₅, R₆, X₁, X₂, X₃, X₄ are not identical, preferably at least one of R₃, R₄, R₅, R₆, X₁, X₂, X₃, X₄ is CH₃, CF₃, F; more preferably at least one of R₃, R₄, R₅, R₆, X₁, X₂, X₃, X₄ is CF₃ or F;

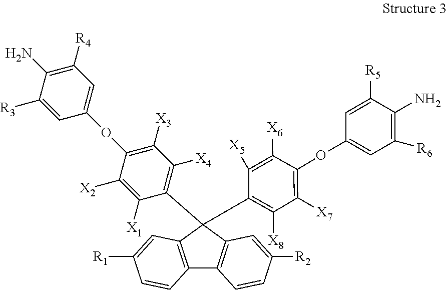

wherein for Structure 3: R₁, R₂, R₃, R₄, R₅, R₆, X₁, X₂, X₃, X₄, X₅, X₆, X₇ and X₈ are each independently H, CH₃, CF₃, F, Cl or Br, with the proviso that at least one of R₃, R₄, R₅, R₆, X₁, X₂, X₃, X₄, X₅, X₆, X₇ and X₈ are not identical, preferably at least one of R₃, R₄, R₅, R₆, X₁, X₂, X₃, X₄, X₅, X₆, X₇, X₈ is CH₃, CF₃, F; more preferably at least one of R₃, R₄, R₅, R₆, X₁, X₂, X₃, X₄, X₅, X₆, X₇, X₈ is CF₃ or F.

In this paragraph Applicants disclose the fluorene containing diamine monomer of the previous paragraph wherein said diamine monomer has Structure 1: wherein for said Structure 1: R₁, R₂, R₃, R₄, R₅ and R₆ are each independently H, CH₃, CF₃, F, Cl or Br, with the proviso that at least one of R₃, R₄, R₅, R₆ are not identical, preferably at least one of R₃, R₄, R₅, R₆ is CH₃, CF₃, F; more preferably at least one of R₃, R₄, R₅, R₆ is CF₃ or F.

In this paragraph Applicants disclose a polyimide polymer comprising a fluorene containing diamine monomer according to the previous two paragraphs with one or more first diamine monomers having structures 1, 2 and/or 3 below:

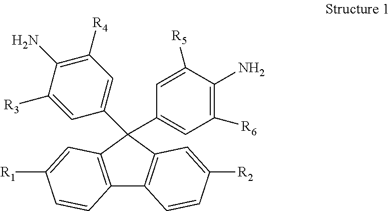

wherein for Structure 1: R₁, R₂, R₃, R₄, R₅ R₆ are each independently is H, CH₃, CF₃, F, Cl or Br, with the proviso that at least one of R₃, R₄, R₅, R₆ are not identical, preferably at least one of R₃, R₄, R₅, Reis CH₃, CF₃, F; more preferably at least one of R₃, R₄, R₅, R₆ is CF₃ or F;

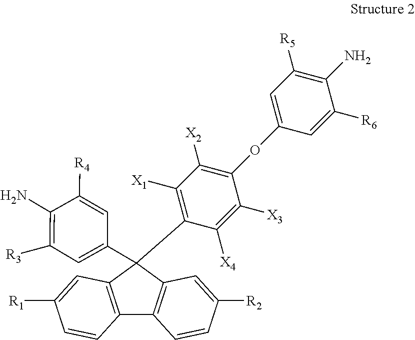

wherein for Structure 2: R₁, R₂, R₃, R₄, R₅, R₆, X₁, X₂, X₃ and X₄ are each independently is H, CH₃, CF₃, F, Cl or Br, with the proviso that at least one of R₃, R₄, R₅, R₆, X₁, X₂, X₃, X₄ are not identical, preferably at least one of R₃, R₄, R₅, R₆, X₁, X₂, X₃, X₄ is CH₃, CF₃, F; more preferably at least one of R₃, R₄, R₅, R₆, X₁, X₂, X₃, X₄ is CF₃ or F;

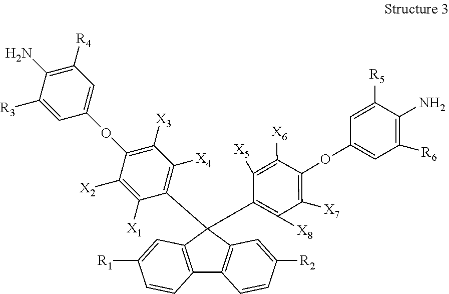

wherein for Structure 3: R₁, R₂, R₃, R₄, R₅, R₆, X₁, X₂, X₃, X₄, X₅, X₆, X₇ and X₈ are each independently H CH₃, CF₃, F, Cl or Br, with the proviso that at least one of R₃, R₄, R₅, R₆, X₁, X₂, X₃, X₄, X₅, X₆, X₇, X₈ are not identical, preferably at least one of R₃, R₄, R₅, R₆, X₁, X₂, X₃, X₄, X₅, X₆, X₇, X₈ is CH₃, CF₃, F; more preferably at least one of R₃, R₄, R₅, R₆, X₁, X₂, X₃, X₄, X₅, X₆, X₇, X₈ is CF₃ or F and at least one optional second diamine monomer having a structure that is different from said Structures 1, 2 and 3.

In this paragraph Applicants disclose a process of making a diamine monomer, said process comprising:
combining, under an inert atmosphere, a polar aprotic solvent and a first molecule having structure of Formula 1 and a second molecule having structure of Formula 2 or Formula 3 below to form the first mixture, said first molecule and said second molecule being combined in a molar ratio from about 1:0.5 to about 1:2, preferably said molar ratio being about 1:1:

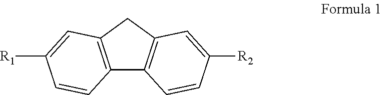

wherein for Formula, 1 R₁, and R₂ are each independently H, CH₃, CF₃, F, Cl or Br; preferably for Formula 1 R₁, and R₂, are each independently CF₃ or F; and the second molecule having structure of Formula 2 or Formula 3 below:

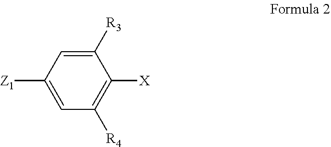

wherein for Formula 2, R₃ and R₄, are each independently H, CH₃, CF₃, F, Cl or Br; Z₁ is H, NO₂ or F; and X is an amino, nitro or acetamido group, preferably R₃ and R₄, are each independently CF₃ or F; Z₁ is F, X is a nitro group;

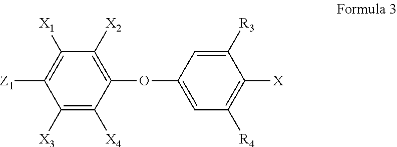

wherein Formula 3, R₃, R₄, X₁, X₂, X₃ and X₄, are each independently H, CH₃, CF₃, F, Cl or Br; Z₁ is H, NO₂, F; X is an amino, nitro or acetamido group, preferably R₃ and R₄, X₁, X₂, X₃ and X₄ are each independently H, CF₃ or F; Z₁ is F; and X is nitro group; preferably said polar aprotic solvent comprises tetrahydrofuran, dimethylformamide, dimethylacetamide, 1-methyl-2-porrylidinone, and/or dimethyl sulfoxide, more preferably said aprotic solvent comprises dimethylformamide, dimethylacetamide, 1-methyl-2-porrylidinone and/or dimethyl sulfoxide, most preferably said aprotic solvent comprises dimethyl sulfoxide; to form a first mixture;
adding a base to said first mixture to form a second mixture, said base being added to said first mixture in a molar ratio of base to the said first molecule in said first mixture of from about 1:1 to about 5:1, preferably said base is added in a molar ratio of base to the said first molecule in said first mixture of about 2:1, preferably said base comprises sodium hydroxide, potassium hydroxide, lithium hydroxide, sodium methoxide, potassium methoxide, sodium tert-butoxide, and/or potassium tert-butoxide, more preferably said base comprises potassium tert-butoxide;
stirring said second mixture for about 1 hour to about 24 hours under an inert atmosphere;
adding an acid to said second mixture to yield a third molecule having Formula 4 or Formula 5 below

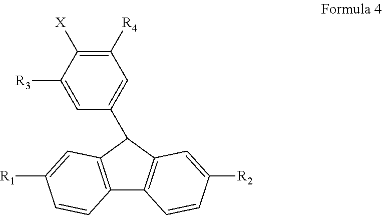

wherein Formula 4, R₃ and R₄ are each independently H, CH₃, CF₃, F, Cl or Br; X is an amino, nitro or acetamido group, preferably R₃ and R₄ are each independently H, CF₃ or F; and X is a nitro group

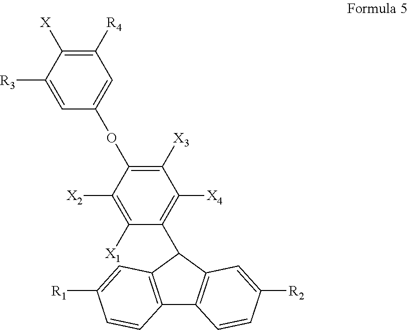

wherein for Formula 5, R₃, R₄, X₁, X₂, X₃, and X₄ are each independently H, CH₃, CF₃, F, Cl or Br; X is an amino, nitro or acetamido group. preferably R₃ R₄, X₁, X₂, X₃ and X₄ are each independently H, CF₃ or F and X is nitro group; oxidizing said third molecule to yield a fourth molecule, said fourth molecule having Formula 6 or Formula 7 below:

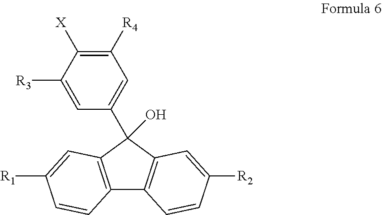

wherein Formula 6, R₃ and R₄ are each independently H, CH₃, CF₃, F, Cl or Br; X is an amino, nitro or acetamido group. preferably R₃ and R₄ are each independently is H, CF₃ or F;

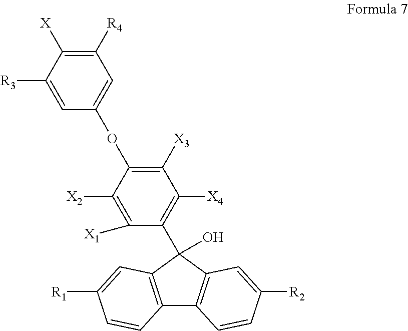

wherein for Formula 7, R₃, R₄, X₁, X₂, X₃ and X₄ are each independently H, CH₃, CF₃, F, Cl or Br; X is an amino, nitro or acetamido group, preferably R₃, R₄, X₁, X₂, X₃ and X₄ are each independently is H, CF₃ or F;
preferably said oxidation is carried out at about 25° C. in an atmosphere that comprises oxygen, said oxidation comprising combining said third molecule with a strong base, the a molar ratio of base to the third molecule from about 0.01:1 to about 1:1, preferably said base is added in a molar ratio of base to the said third molecule 0.1:1, preferably said base is chosen from sodium hydroxide, potassium hydroxide, lithium hydroxide, sodium methoxide, potassium methoxide, sodium tert-butoxide, potassium tert-butoxide, most preferable strong base is potassium tert-butoxide, and an aprotic solvent, preferably said aprotic solvent comprises tetrahydrofuran, dimethylformamide, dimethylacetamide, 1-methyl-2-porrylidinone and/or dimethyl sulfoxide, more preferably said aprotic solvent comprises tetrahydrofuran and/or dimethyl sulfoxide; to form a third mixture and stirring said third mixture for about 1 hour to about 48 hours optional, when peroxide is formed, a reduction agent is introduced at the end of reaction, preferably said reduction reagent comprises sodium borohydride, lithium borohydride, potassium borohydride, hydrazine, lithium aluminum hydride, Zinc and/or iron, more preferably said reduction reagent comprises sodium borohydride, lithium borohydride to yield, after said addition of said reduction reagent, to yield said fourth;
combing said second molecule, said fourth molecule, a solvent, preferably said solvent comprise methylene chloride, acetic acid and/or nitrobenzene, more preferably solvent comprise acetic acid, and a strong acid, preferably said strong acid comprises hydrochloric acid, acetic acid, methanesulfonic acid, sulfuric acid and/or nitric acid, more preferably said strong acid comprises hydrochloric acid and/or methanesulfonic acid, to form a fourth mixture, heating said fourth mixture to a temperature of about 40° C. to about 150° C. and holding said fourth mixture at said temperature for 1 to 48 hours to yield a fifth molecule, said fifth molecule having Formula 8, 9 or 10 below:

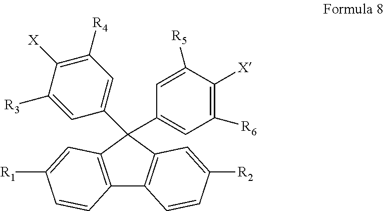

wherein for Formula 8, R₁, R₂, R₃, R₄, R₅ and R₆ are each independently H, CH₃, CF₃, F, Cl or Br; X and X′ are each independently an amino, nitro or acetamido group; preferably at least one of R₃, R₄, R₅ or R₆ is CH₃, CF₃ or F; more preferably at least one of R₃, R₄, R₅ or R₆ is CF₃ or F, and at least one of X and X′ is an acetamido group;

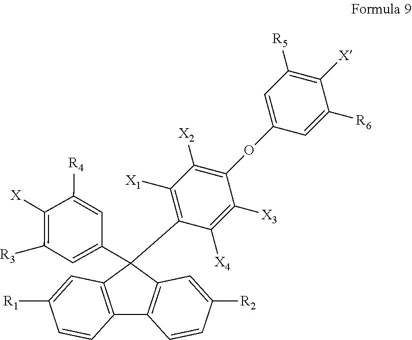

wherein for Formula 9: R₁, R₂, R₃, R₄, R₅, R₆, X₁, X₂, X₃ and X₄ are each independently H, CH₃, CF₃, F, Cl or Br, X and X′ are each independently an amino, nitro or acetamido group; preferably at least one of R₃, R₄, R₅, R₆, X₁, X₂, X₃ or X₄ is CH₃, CF₃ or F; more preferably at least one of R₃, R₄, R₅, R₆, X₁, X₂, X₃ or X₄ is CF₃ or F, and at least one of X and X′ is an acetamido group;

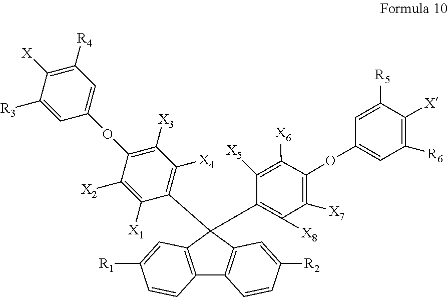

wherein for Formula 10: R₁, R₂, R₃, R₄, R₅, R₆, X₁, X₂, X₃, X₄, X₅, X₆, X₇, and X₈ are each independently H, CH₃, CF₃, F, Cl or Br, and X and X′ are each independently an amino, nitro or acetamido group; preferably at least one of R₃, R₄, R₅, R₆, X₁, X₂, X₃, X₄, X₅, X₆, X₇ and X₈ is CH₃, CF₃ or F; more preferably at least one of R₃, R₄, R₅, R₆, X₁, X₂, X₃, X₄, X₅, X₆, X₇ and X₈ is CF₃ or F, and at least one of X and X′ is an acetamido group; and
optionally, combining said third molecule with a polar aprotic solvent to form a fifth mixture, combining said fifth mixture with a strong base under an inert atmosphere to form a solution comprising a salt, adding said second molecule to said solution to yield a sixth molecule, said sixth molecule having Formula 10, Formula 11 or Formula 12:

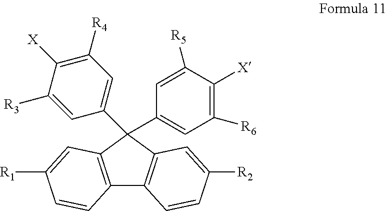

wherein for Formula 11, R₁, R₂, R₃, R₄, R₅ and R₆ are each independently H, CH₃, CF₃, F, Cl or Br; X and X′ are each independently an amino, nitro or acetamido group; preferably at least one of R₃, R₄, R₅ or R₆ is CH₃, CF₃ or F; more preferably at least one of R₃, R₄, R₅ or R₆ is CF₃ or F, and at least one of X and X′ is a nitro group

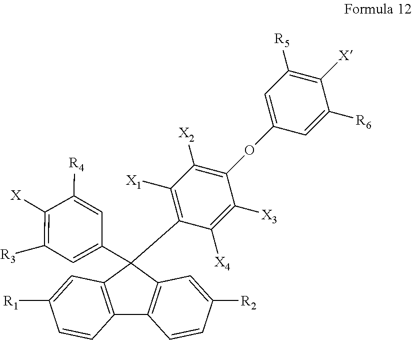

wherein for Formula 12: R₁, R₂, R₃, R₄, R₅, R₆, X₁, X₂, X₃ and X₄ are each independently H, CH₃, CF₃, F, Cl or Br, X and X′ are each independently an amino, nitro or acetamido group; preferably at least one of R₃, R₄, R₅, R₆, X₁, X₂, X₃ or X₄ is CH₃, CF₃ or F; more preferably at least one of R₃, R₄, R₅, R₆, X₁, X₂, X₃ or X₄ is CF₃ or F, and at least one of X, and X′ is a nitro group

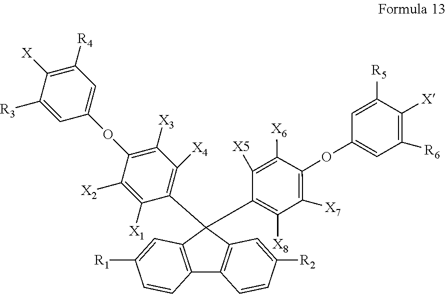

wherein for Formula 13: R₁, R₂, R₃, R₄, R₅, R₆, X₁, X₂, X₃, X₄, X₅, X₆, X₇, and X₈ are each independently H, CH₃, CF₃, F, Cl or Br, and X and X′ are each independently an amino, nitro or acetamido group; preferably at least one of R₃, R₄, R₅, R₆, X₁, X₂, X₃, X₄, X₅, X₆, X₇ and X₈ is CH₃, CF₃ or F; more preferably at least one of R₃, R₄, R₅, R₆, X₁, X₂, X₃, X₄, X₅, X₆, X₇ and X₈ is CF₃ or F, and at least one of X and X′ is a nitro group;
when for said fifth and sixth molecule X and/or X′ are not amino groups, said X and/or X′ are converted into amino groups by reducing any of X and X′ that is a nitro group and by hydrolyzing any X or X′ that is an acetamido groups.

In this paragraph Applicants disclose a process of making the polyimide polymer of the third paragraph of this section of this specification titled “Fluorene Containing Diamine Monomer And Process Of Making And Using Same In Polymers As Well As Articles And Compositions Comprising Said Polymer”, said process comprising reacting via a condensation reaction a first diamine monomer, said first diamine monomer being a diamine monomer according to the first two paragraphs of this section of this specification titled “Fluorene Containing Diamine Monomer And Process Of Making And Using Same In Polymers As Well As Articles And Compositions Comprising Said Polymer” with one or more dianhydrides and one or more optional second diamine monomers.

In this paragraph Applicants disclose the process of the previous paragraph wherein said one or more dianhydrides are selected from the group consisting of dianhydrides having the structures below and mixtures thereof:

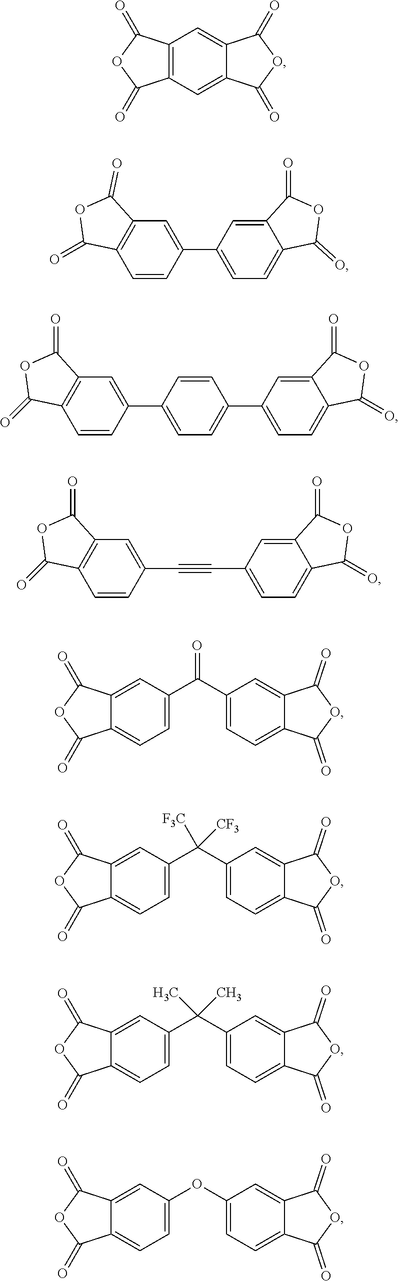

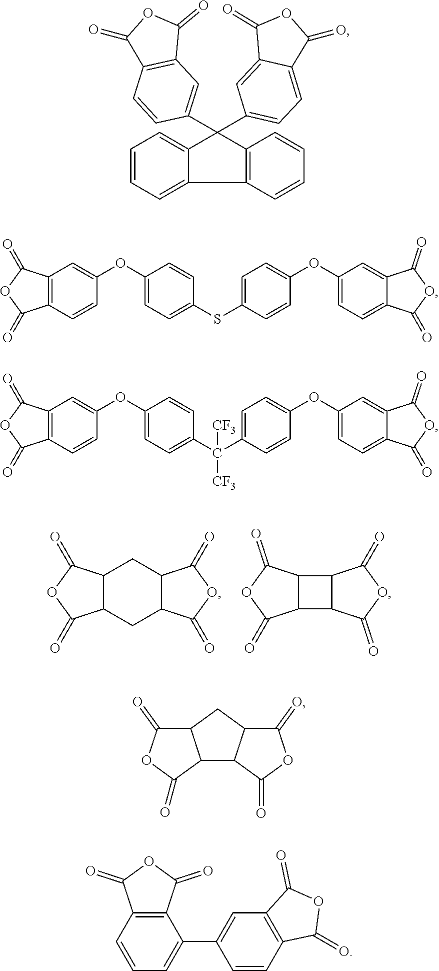

preferably dianhydrides said dianhydride is selected from the group consisting of dianhydrides having the structures below and mixtures thereof

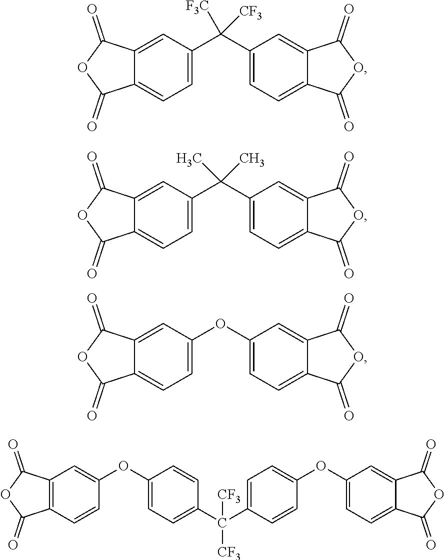

more preferably said dianhydride is selected from the group consisting of dianhydrides having the structures below and mixtures thereof

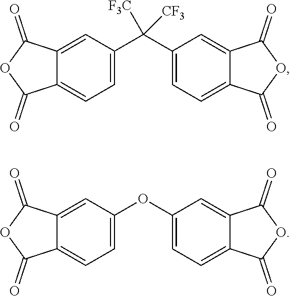

In this paragraph Applicants disclose the process of the previous two paragraphs wherein said first diamine monomer has Structure 1 and/or Structure 2 of the first paragraph of this section of this specification titled “Fluorene Containing Diamine Monomer And Process Of Making And Using Same In Polymers As Well As Articles And Compositions Comprising Said Polymer”, preferably said first diamine monomer has Structure 1 of the first paragraph of this section of this specification titled “Fluorene Containing Diamine Monomer And Process Of Making And Using Same In Polymers As Well As Articles And Compositions Comprising Said Polymer”.

In this paragraph Applicants disclose the process of the previous paragraph wherein the molar ratio of said second diamine to said first diamine is from about 0.005:1 to about 2.0:1, preferably the molar ratio of said second diamine to said first diamine is from about 0.1:1 to about 0.4:1; more preferably the molar ratio of said second diamine to said first diamine is from about 0.1:1 to 0.3:1.

In this paragraph Applicants disclose the process of the previous three paragraphs wherein the molar ratio of total diamines to said total dianhydrides is from about 0.95:1 to about 1:0.95, preferably the molar ratio of said total diamines to said total dianhydrides is from about 0.9:1 to about 1.1:1; more preferably the molar ratio of said total diamine to total dianhydrides is from about 0.98:1 to about 1.02:1; most preferably the molar ratio of said total diamines to said total dianhydrides is from about 0.99:1 to about 1.01:1.

In this paragraph Applicants disclose an article comprising a polyimide according to the third paragraph of this section of this specification titled “Fluorene Containing Diamine Monomer And Process Of Making And Using Same In Polymers As Well As Articles And Compositions Comprising Said Polymer”, preferably said article is an electronic chip or electronic circuit board for automobiles, ship, rocket, airplane, spacecraft and satellite.

In this paragraph Applicants disclose a composition comprising one or more solvents, a polyimide polymer according to the third paragraph of this section of this specification titled “Fluorene Containing Diamine Monomer And Process Of Making And Using Same In Polymers As Well As Articles And Compositions Comprising Said Polymer” and one or more optional adjuncts, said composition being a coating, an adhesive or a prepreg solution; preferably said one or more solvents are selected from the group consisting of 1-methyl-2-pyrrolidinone, dimethylacetamide, dimethylformamide, dimethyl sulfoxide, tetrahydrofuran, ethylene glycol monomethyl ether, ethylene glycol butyl ether, ethylene glycol ethyl ether, 2-butanone, acetone, methyl isobutyl ketone, methyl amyl ketone, cyclohexanone, isophorone and mixtures thereof, ethyl acetate, ethylene glycol monoethyl ether acetate, n-butyl acetate, isobutyl acetate; more preferably said one or more solvents are selected from the group consisting of tetrahydrofuran, ethylene glycol butyl ether, ethylene glycol ethyl ether, 2-butanone, acetone, methyl isobutyl ketone, methyl amyl ketone, cyclohexanone, isophorone, ethyl acetate, n-butyl acetate, isobutyl acetate and mixtures thereof; most preferably said one or more solvents are selected from the group consisting of 2-butanone, methyl isobutyl ketone, methyl amyl ketone, cyclohexanone, isophorone, ethyl acetate, n-butyl acetate, isobutyl acetate and mixtures thereof.

In this paragraph Applicants disclose the composition of the previous paragraph, wherein said polyimide polymer comprise one or more functional groups, preferably said functional groups are selected from the group consisting of a hydroxy moiety, a vinyl moiety, an acrylic moiety, a methacrylic moiety, an epoxy moiety, a phenylethynyl moiety and mixtures thereof.

In this paragraph Applicants disclose the composition of the previous two paragraphs wherein said polyimide polymer has a weight percentage of repeat units, based on total polyimide polymer, of from about 40% to about 99%, preferably said polyimide polymer has a weight percentage of repeat units, based on total polyimide polymer, of from about 50% to about 90%, most preferably said polyimide polymer has a weight percentage of repeat units, based on total polyimide polymer, of from about 70% to about 99%.

In this paragraph Applicants disclose the composition of the previous three paragraphs wherein said polyimide polymer comprises one or more functional groups selected from the group consisting of a hydroxy moiety, a vinyl moiety, an acrylic moiety, a methacrylic moiety, an epoxy moiety, a phenylethynyl moiety and mixtures thereof, said functional groups being present in said polyimide polymer, based on total polyimide polymer weight, in a range of from about 0.5% to about 60%, preferably said functional groups being present in said polyimide polymer, based on total polyimide polymer weight, in a range of from about 1% to 40%, most preferably said functional groups being present in said polyimide polymer, based on total polyimide polymer weight, in a range of from about 2% to 20%.

In this paragraph Applicants disclose the composition of the previous four paragraphs wherein said composition has a polyimide solid content, based on total composition weight, of from about 0.5% to about 50%, preferably said composition has a polyimide solid content, based on total composition weight, of from about 1% to about 40%, most preferably said composition has a polyimide solid content, based on total composition weight, of from about 2% to about 20%.

In this paragraph Applicants disclose the composition of the previous five paragraphs said composition comprising an adjunct material, said adjunct material comprising a reinforcing filler, a dye, a pigment, a photo radical initiator, a thermal initiator, photo cationic initiator salt, photo anionic initiator salt, and/or an inorganic salt.

In this paragraph Applicants disclose the composition of the previous paragraph wherein said reinforcing filler comprises chopped carbon fiber, carbon fiber fabric, chopped glass fiber, glass fiber fabric, metal oxide particulates, metal particulates and/or nano particles. The size of the metal oxide particulates, metal particulates is typically from about 0.1 micrometers to about 100 micrometers.

In this paragraph Applicants disclose the composition of the previous two paragraphs wherein said photo radical initiator is selected from the group consisting of 2,4,6-trimethylbenzoyldiphenylphosphine oxide; bis(2,4,6-trimethylbenzoyl)phenylphosphine oxide; bis(2-ethylhexyl)phosphine oxide; phenyl[bis(2-phenylethyl)]phosphine oxide and mixtures thereof.

In this paragraph Applicants disclose the composition of the previous three paragraphs wherein said thermal initiator is selected from the group consisting of azobisisobutyronitrile; benzoyl peroxide; 2,2-bis(tert-butylperoxy) butane; 1,1-bis(tert-butylperoxy)-3,3,5-trimethylcyclohexane; tert-butyl hydroperoxide; 2,4-pentanedione peroxide; 2,5-bis(tert-butylperoxy)-2,5-dimethylhexane and mixtures thereof.

In this paragraph Applicants disclose the composition of the previous four paragraphs wherein wherein said inorganic salt is selected from the group consisting of iron (III) chloride, nickel chloride, copper(II) chloride, cobalt(III) chloride, iron(III) bromide, nickel bromide, cobalt(III) bromide, palladium chloride, palladium acetate and mixtures thereof.

In this paragraph Applicants disclose the composition of the previous five paragraphs wherein wherein said cationic photo initiator salt is selected from the group consisting of bis(4-tert-butylphenyl) iodonium hexafluorophosphate, 2-(1,3-benzodioxol-5-yl)-4,6-bis(trichloromethyl)-1,3,5-triazine, bis(4-tert-butylphenyl) iodonium tetrafluoroborate, bis[4-(tert-butyl)phenyl]iodonium tetra(nonafluoro-tert-butoxy)aluminate, bis(4-tert-butylphenyl) iodonium nonafluoro-1-butanesulfonate, bis(4-tert-butylphenyl) iodonium hexafluoroantimonate, bis(4-tert-butylphenyl) iodonium chloride, diphenyliodonium hexafluoroarsenate, nitrobenzenediazonium tetrafluoroborate, cyclopentadienyliron(ii) hexafluorophosphate, and mixtures thereof.

In this paragraph Applicants disclose the composition of the previous six paragraph wherein said anionic photo imitator salt is selected from the group consisting of 2-(9-oxoxanthen-2-yl) propionic acid 1,5,7-triazabicyclo[4.4.0]dec-5-ene salt, 2-(9-oxoxanthen-2-yl) propionic acid 1,5-diazabicyclo[4.3.0]non-5-ene salt, 2-(9-oxoxanthen-2-yl) propionic acid 1,8-diazabicyclo[5.4.0]undec-7-ene salt, and mixtures thereof.

In this paragraph Applicants disclose an article comprising a composition according to the previous twelve paragraphs, preferably said article is an electronic chip or electronic circuit board.

In this paragraph Applicants disclose an automobile, ship, rocket, airplane, spacecraft or satellite comprising the article of the previous paragraph.

Processable polyimides with high glass transition temperature great than 270° C. are rare. Thermosetting polyimide resins are dominating players for the extreme aerospace and defense operating temperatures in the range of 260-371° C. (500-700° F.). The current state of art of high temperature polyimide resin is based on crosslinkable polyimide chemistry. P. M. Hergenrother et al taught us in United State U.S. Pat. No. 5,760,168, “Imide oligomers endcapped with phenylethynyl phthalic anhydrides and polymers therefrom”, that crosslink chemistries enable higher polyimide service temperature. The above-mentioned patent also indicated that the oligomer exhibited poor solubility in DMAc as the imidized oligomer will precipitate out of reaction mixture. Typically, the crosslinking (curing) process is performed at high temperature and is a not a reversible process. Once the thermoset is made, it is impossible to reconfigure or reprocess the material. Hence, the disadvantages of thermosetting polyimide resins include: 1) the oligomeric polyimides are not soluble in most common solvents; thus composites must be prepared via melt compounding or must be prepared by solution compounding at soluble polyamic acid stage; 2) thermoset composites are not recyclable and reconfigurable; 3) the curing process must be carried out at high temperature (close to or above glass transition temperature of polyimide resin) which may not be suitable for preparation of a composite comprising thermally sensitive components.

Hence, the thermosetting polyimide resin is not suitable to encapsulate temperature sensitive objects. The capability to prepare polyimide-based high temperature composite(s) in solution at mild temperature (e.g., room temperature) is highly desirable for many applications. From the recyclability and reconfigurability prospect, soluble polyimide resin is highly desirable. Recently Loon-Seng Tan, Zhenning Yu, et. al, disclosed in U.S. Pat. No. 11,296,726 B2, “Polyimide-gold-nanorod j-aggregates with broadened surface plasmonic resonance band and method of manufacture”, demonstrating that soluble polyimides can be used to prepare polyimide composites in solution. However, the patent application does not include any polyimide comprising diamines with fluorene moieties. Furthermore, the patent application only applied to composites made of polyimide with gold nanorods. This current invention provides a method to prepare highly soluble polyimide with glass transition temperature above 270° C. that demonstrate solubility in common organic solvents and a method to prepare the said polyimide with other components to form a coating or polymeric matrix composite. The practice of solution-based coating for industrial applications must also consider the solvent's chemical compatibility with the object or substrate being coated in addition to the solvent's life cycle impacts which include the solvent's safety, toxicity, waste disposal requirements and impact to environment. Raj Joshi R et. al in Journal of Pharmaceutical Research International, 2019, 28 (3) 1-28 mentioned that Pfizer's Medicinal Chemistry Solvent Selection Guide while discuss of common solvents and their toxicity. Based on the guide, the currently commonly used solvents for polyimide coating applications, such as DMAc and NMP, are not considered as desirable solvents. Examples of preferred organic solvents are ethyl acetate and methylethylketone. Hence, polyimides with good solubility in a variety of organic solvents are increasingly important for aerospace or commercial applications. Organic soluble polyimides have previously been developed by many entities, such as LaRC-CP2™ (NASA), Ultem® (SABIC), and Matrimid®5218 (Huntsman). These polyimides provide a more expansive selection of soluble solvents in addition to DMAc and NMP. For example, LaRC-CP2 exhibits good solubility in dichloromethane (DMC), chloroform, and tetrahydrofuran (THF). Table 1 provides a summary of our solubility test results for 10 mg of polyimide in 1 mL each of the 15 commons solvents. Our evaluation indicates none of above-mentioned polyimides is soluble in ethyl acetate. Only LaRC-CP2 is soluble in methyl ethyl ketone. Hence, there is urgent need to develop novel polyimides with better solubility in ester or ketone types of solvents.

TABLE 1
Solubility test results of LaRC-CP2 ™ (NASA), Ultem ® 1000
(SABIC), and Matrimid ®5218 (Huntsman).

| | Solubility at 20° C. | | |
|---|---|---|---|
| | (1 = soluble, 0 = not soluble, | | |
| | S = swelled, but not soluble) | | |
| Solvent | LaRC-CP2 ™ | Ultem ®1000 | Matrimid ®5218 |
| Chloroform | 1 | 1 | 1 |
| m-Cresol | 1 | 1 | 1 |
| Diethyl ether | 0 | 0 | 0 |
| Dimethyl sulfoxide | 1 | S | 1 |
| Ethanol | 0 | 0 | 0 |
| Ethyl acetate | S | S | 0 |
| Hexanes | 0 | 0 | 0 |
| Methyl Ethyl | 1 | S | 0 |
| Ketone | | | |
| NMP | 1 | 1 | 1 |
| DCM | 1 | 1 | 1 |
| DMAc | 1 | 1 | 1 |
| Dimethylforamide | 1 | S | S |
| 2-Propanol | 0 | 0 | 0 |
| THF | 1 | S | 1 |
| Toluene | S | 0 | 0 |

For soluble polyimide used as high temperature coating binder, T_{g} is one of the important thermal properties. Said polymers can be used for long term at temperatures from 270° C. to 370° C.; and for a short time above 370° C. Ideally, the glass transition of the said polyimide is above 350° C. Of the above mentioned three commercially available soluble polyimides, only Matrimid® 5218 exhibits a T_{g} above 300° C. but less than 350° C. As taught by Langsam M. et al. in Journal of Polymer Science, Part A: Polymer Chemistry, 1993, 31, 900-921, polyimides made from 9H-Fluoren-9-ylidene bis(aniline) and (Hexafluoroisopropylidene)diphthalic (6FDA), exhibit glass transition temperatures as high as 355° C. As Moy, T. M et al. Polymer, 1993, 34, 819-824, disclosed that polyimide oligomer made from variety of anhydride with 4,4′-(9-Fluorenylidene)dianiline (FDA) is soluble in DMAc. Chun, B in Polymer, 1994, 4203-4206 disclosed polyimides made from condensation of FDA with 6FDA or bicyclo[2.2.21-oct-7-ene-2,3,5,6-tetracarboxylic dianhydride (BCDA) showing good solubility in DMAc, NMP, THF and chloroform, but not in ethyl acetate. Hence, fluorene moieties containing bis(aniline) monomer, such as FDA, enable the resultant polyimide a high T_{g} (300° C. or above) and good solubility in organic solvents. In the past, polyimide solubility evaluations were focused on solvents such as NMP, DMAc, pyridine, m-cresol, chloroform, THF; seldom ester containing solvents such as ethyl acetate or ketone-based solvents such as methyl ethyl ketone were investigated. Our invention is focused on polyimide solubility in many common solvents, especially ester solvents such as ethyl acetate and ketone-based solvents such methyl ethyl ketone.

Furthermore, our investigation also indicates, even by employing substituted FDA as monomers, the solubility of resultant polyimides in a specific solvent is not obviously guaranteed. For example, 4,4′-(2,7-difluoro-9H-fluorene-9,9-diyl)dianiline (FDA-27F) and 4,4′-(9H-fluorene-9,9-diyl)bis(2-fluoroaniline) (FDA-F) are isomeric species. Structure of FDA-F and isomeric structure of FDA-27F are shown below:

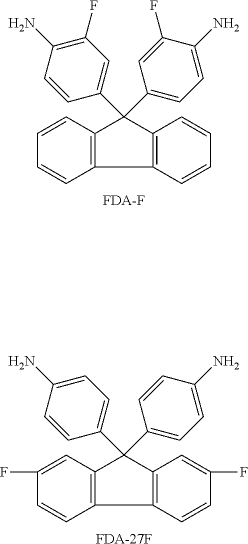

These two monomers were polymerized with 6FDA to form respective polyimides, which were named as 6FDA-FDA-27, and 6FDA-FDA-F respectively. The solubility test results of these two polyimides in 15 common solvents are shown in Table 2. Our testing results indicate that 6FDA-FDA-F is soluble in ethyl acetate and methyl ethyl ketone, but 6FDA-FDA-27 is not soluble in above two solvents. Hence, this invention discloses a method to prepare polyimide with better solubility in common solvents other than alcohols and hydrocarbons is significant and not obvious.

TABLE 2
Solubility test result of 6FDA-FDA-F and 6FDA-FDA-27F

Solubility at 20° C.
(1 = soluble, 0 = not soluble,
S = swelled, but not soluble)

| Solvent | 6FDA-FDA-27F | 6FDA-FDA-F |
|---|---|---|
| Chloroform | 1 | 1 |
| m-Cresol | 1 | 1 |
| Diethyl ether | 0 | 0 |
| Dimethyl sulfoxide | 1 | 1 |
| Ethanol | 0 | 0 |
| Ethyl acetate | 0 | 1 |
| Hexanes | 0 | 0 |
| Methyl Ethyl Ketone | 0 | 1 |
| NMP | 1 | 1 |
| DCM | 1 | 1 |
| DMAc | 1 | 1 |
| Dimethyforamide | 1 | 1 |
| 2-Propanol | 0 | 0 |
| THF | 1 | 1 |
| Toluene | 0 | 0 |

In order to precisely control solubility in a specific organic solvent or solvent mixture, preferable ester- and/or ketone based solvent or solvent mixture, and at the same time keep the T_{g} of the resultant polyimide at 270° C. or above, this invention is focusing on two aspects of molecular engineering: 1) making substituted fluorene moieties containing diamines and applying such diamines to make solution processable high T_{g} polyimides, 2) tuning solubility via copolymerization of more than one diamines and/or more than one dianhydrides to achieve better solubility control in specific solvent or solvent mixture. A generic structure of fluorene moiety containing diamine is show as the following:

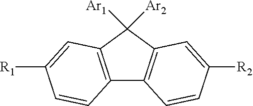

Brief description of the generic structure of the diamine, 9-Ar₁,9-Ar₂,-2-R₁, 7-R₂-fluorene. The core of the diamine is 2,7-disubstituted fluorene moiety. There is an R₁ substitution at the 2 position and an R₂ substitution at the 7 position. Ar₁ and Ar₂ at 9 positions are two amino containing aromatic groups. To precise control of the solubility of the resultant polyimide in a given solvent, Ar₁ and Ar₂ must be carefully chosen. When Ar₁ and Ar₂ are different, it is called an asymmetric diamine. When Ar₁ and Ar₂ are the same, we call it a symmetric diamine. The synthesis of the symmetric diamine can be found, for example, in Hui-Min Guan et al in Dyes and Pigments, 2021, 186, 109019, wherein the diamine FDA is obtained by reaction of aniline with 9-fluorenone. Ching-Hsin Chen et al in Journal of Polymer Science: Part A: Polymer Chemistry, 2004, 42, 3314-3322, disclosed a method to make the precursor of FDA, 9,9-Bis(4-nitrophenyl) fluorene. If these methods are employed to make asymmetric diamine, the resultant product will be a mixture of three diamines and separating these three diamines are almost impossible because they have very similar chemical and physical properties. The reason is due to Ar₁ and Ar₂ were installed onto 9 position of fluorene matrix in sequence without being isolated from the intermediates. Due to the nature of these reaction conditions, it is impossible to isolate the intermediate. Hence the current state art of fluorene moiety containing diamines synthesis is not enough to efficiently make asymmetric diamine. Our invention is to synthesize the diamine in a stepwise way fashion to install Ar₁ and Ar₂. The synthesis of fluorene moiety containing diamine by stepwise substituting two 9-protons of 2-(R₁), 7-(R₂) fluorene with aromatic moieties (Ar₁ and Ar₂) is as follows:

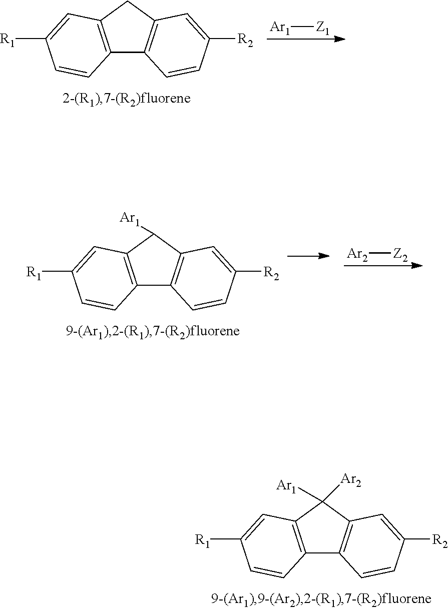

The Proton at 9-position of fluorene is relative acidic and can be deprotonated resulting in an anionic species which can be used as a nucleophile. For example, Kaitlyn Lovato et al in Chemical Science, 2018, 9, 7992-7999, disclosed that 9-(4-nitrophenyl) fluorene can be obtained via aromatic nucleophilic substitution. 9-phenyl-9H-fluoren-9-ol can form a bond with acetanilide via electrophilic substitution reaction to form 4-(9-phenyl-9H-fluoren-9-yl) aniline after one pot deprotection, as described in Hui-Min Guan et al Dyes and Pigments, 2021, 186, 109019.

Synthesis of 9-(Ar₁)-2-(R₁),7-(R₂) fluorene compound can be carried out using readily available fluorene compound such as 2-R₁,7-R₂ substituted fluorene, treated the 2-(R₁), 7-(R₂) fluorene, with 2 molar equivalents of strong base in a polar solvents, then, reacted with 1 equivalent of Ar₁ Z₁ under aromatic nucleophilic substitution condition. Usually Z₁ is fluoro, which serves as the leaving group of the aromatic nucleophilic substitution. The resultant 9-(Ar₁),2-(R₁),7-(R₂) fluorene can be obtained after neutralization. The said 9-(Ar₁),2-(R₁), 7-(R₂) fluorene can be isolated and purified for future use. It is also possible to make 9-(Ar₁),2-(R₁),7-(R₂) fluorene via electrophilic substitution by employing 9-hydroxy,2-(R₁), 7-(R₂) fluorene as the starting material. The preferable amino source on Ar₁ is acetamido group, and the leaving group Z₁ is usually hydrogen for the electrophilic substitution reactions.

To substitute the 9-hydrogen of 9-(Ar₁),2-(R₁), 7-(R₂) fluorene with Ar₂, there are two possible routes which are shown below as route 1 and route 2. The route 1 process is an aromatic nucleophilic substitution, in which the said 9-(Ar₁),2-(R₁), 7-(R₂) fluorene can be treated with 1 equivalent of strong base in polar solvents, then reacts with Ar₂Z₂ under aromatic nucleophilic substitution condition to give the 9-(Ar₁),9-(Ar₂), 2-(R₁), 7-(R₂) fluorene. Preferably, Ar₂ contains a nitro group or other electron withdrawing amino precursor to facilitate aromatic nucleophilic substitution. The nitro group can then be converted to an amino group readily following known nitro reduction reactions. However, due to steric hinderance effects, installing the Ar₂ group via aromatic nucleophilic substitution may not be efficient. Substituting the 9-position hydrogen with Ar₂ group usually proceeds very slow, the reaction needs to be carried out at elevated temperatures, and the yield of product is poor to moderate. Hence, route 2 is preferable based on better yield. The said 9-(Ar₁ ′, 2-(R₁), 7-(R₂) fluorene can be converted to 9-hydroxy,9-(Ar₁)-2-(R₁), 7-(R₂) fluorene by oxidation. Mieczysław Makosza et al in Journal of Organic Chemistry 2001, 66, 5022-5026 gave us insight into the possibility of making 9-(4-Nitrophenyl)-9H-fluoren-9-ol via oxidation of 9-(4-Nitrophenyl)-9H-fluorene. However, there was no reaction condition reported. This invention discloses a practical oxidation process by using catalytic amounts of base. The said 9-hydroxy,9-(Ar₁)-2-(R₁), 7-(R₂) fluorene can be converted into an electrophilic specie under strong acidic condition and react with Ar₂Z₂ to give 9-(Ar₁),9-(Ar₂), 2-(R₁), 7-(R₂) fluorene. In the electrophilic substitution condition, the leaving group Z₂ is usually hydrogen. Under electrophilic substitution condition, the preferable amino source on Ar₂ group is acetamido group, which is reasonably stable and will not dramatically hinder the reaction rate of the electrophilic substitution.

Two synthetic routes to make 9-Ar₁,9-Ar₂, 2-(R₁), 7-(R₂) fluorene from 9-Ar₁,2-(R₁),7-(R₂) fluorene. Route 1, aromatic nucleophilic substitution reaction. Route 2, oxidation, electrophilic substitution reaction are as follows:

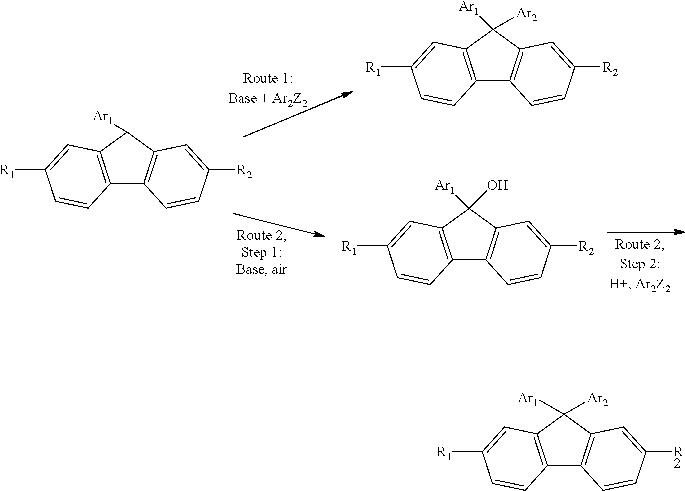

For any polyimide which is made using the condensation of dianhydride(s) and diamine(s), both monomers contribute to the solubility of the resultant polyimide. Tianyun Li et al in RSC Advances, 2017, 7, 40996-41003 gave insight that polyimides made with 6FDA and exhibit solubility in THF and partially solubility in hot acetone. Polyimides made with 4,4′-Oxydiphthalic anhydride (ODPA) are soluble in THF but not in Acetone. Compared to polyimides with the same diamine, the polyimide made with 6FDA exhibits higher T_{g} than those made with ODPA. Hence, 6FDA is the most preferable dianhydride for making polyimides with high solubility in organic solvents and high T_{g}.

For specific application, the desirable polyimide solubility may be need fine-tuned to meet specific solvent and solubility requirement without scarifying high T_{g} property. One way this can be achieved is through combining more than on diamine or dianhydride resulting in a copolymer. Jinfeng Hu et al in High Performance Polymers 2019, 31, 1272 1279 describes the copolymerization of ODPA and 3,3′,4,4′-Biphenyltetracarboxylic dianhydride (BPDA) with 4,4′-(1,3-phenylenedioxy)dianiline, it was possible to make co-polyimide exhibit good solubility in aprotic solvents and at the same time maintaining good thermal performance. Hence, it is equally important to develop a new diamine that has good solubility while maintaining high thermal performances or achieve a similar performance via co-polymerization. Copolymerization may serve as an additional tool for fine tuning the final product's properties. Using said polyimide to preparation of polyimide composite can be carried by solution blending process as the following: Method 1: Combining the said polyimide in a solution with any other components of the composites by mixing, then, remove the solvent by evaporation of the solvent vacuum drying process; or by convection drying at room temperature or elevated temperature; Method 2: Combining the said polyimide solution with any other components of the composites by mixing, then adding a poor solvent to the polyimide mixture, until polyimide and other components co-precipitate at the same time. The precipitation is harvested via common liquid/solids separation methods such as filtration or centrifugation; Method 3: Suspending or dissolving other composite component(s) in a poor solvent to polyimide, then combining the said solution or suspension with the polyimide solution to induce a co-precipitation. The precipitation is harvested via common liquid/solids separation methods such as filtration or centrifugation. Further drying can be done by vacuum drying, convection drying at room temperature or elevated temperature.

One of the important aspects of polymers soluble in common, low toxic solvents is that it can maintain good thermal properties and processability with limited environmental and health impacts. The good solubility enables the said polyimide to be reused, recycled or reconfigured through the re-dissolving process.

### Test Method

For purposes of this specification the glass transition temperature of a polymer should be determined by differential scanning calorimetry (DSC), using a TA Discovery DSC 2500 or equivalent under nitrogen atmosphere with a heating scan rate of 10° C./min.

### Examples

### Example 1 Synthesis of 9-(4-nitrophenyl)-9H-fluorene

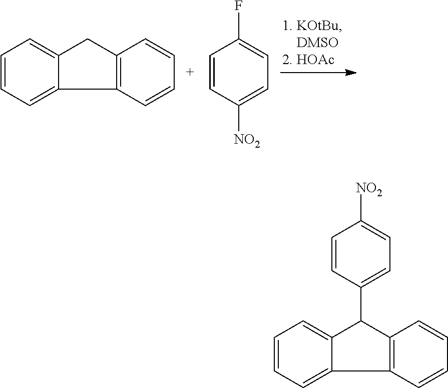

To a 300 mL three necked round bottom flask equipped with magnetic stir bar and nitrogen inlet and outlet, 16.62 g (0.10 mol) fluorene, 14.11 (0.1 mol) 1-fluoro-4-nitrobenzene and 100 mL dimethyl sulfoxide were charged. To the mixture, 22.42 g (0.2 mol) potassium tert-butoxide was charged in small portions over 5 hours. After addition of potassium tert-butoxide, the mixture was stirred under nitrogen for additional 16 hours. Acetic acid was added slowly to the mixture until the blue color disappeared. The mixture was then poured into water. The mixture was extracted with ethyl acetate for three times. The combined ethyl acetate layer was washed with deionized water for three times, then, dried over anhydrous sodium sulfate. After ethyl acetate was removed, the crude product was obtained as brownish yellow solids. The crude product was washed with 50 mL methanol for three times, then, air dried, without further purification. 18.9 grams of product was obtained, 65.7% isolate yield, m.p. 136.1-138.1° C. ¹H NMR (400 MHZ, CDCl₃) δ=8.10-8.13 (d, J=8.8 Hz, 2H), 7.81-7.83 (d, J=8.4 Hz, 2H), 7.39-7.44 (dd, J=2.0, 8.4 Hz 2H), 7.22-7.30 (m, 6H), 5.13 (s, 1H). ¹³C NMR (101 MHZ, CDCl₃) δ=149.64, 146.96, 146.42, 141.04, 129.09, 127.91, 127.61, 125.15, 123.99, 120.19, 53.87.

### Example 2 Synthesis of 9-(4-nitrophenyl)-9H-fluoren-9-ol

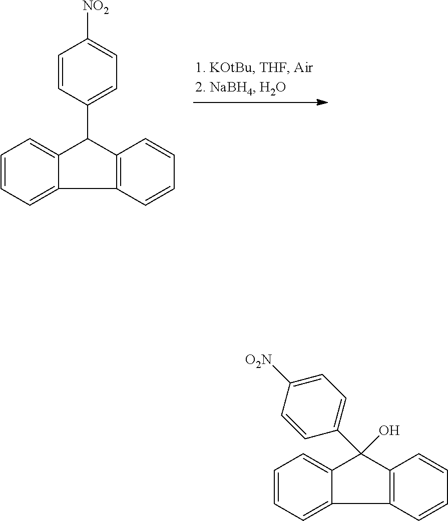 [SMILES: O=[N+]([O-])c1ccc(C2c3ccccc3-c3ccccc32)cc1 ; O=[N+]([O-])c1ccc(C2(O)c3ccccc3-c3ccccc32)cc1]

To a 300 mL round bottom flask equipped with magnetic stir bar. 14.37 g (50.0 mmol) 9-(4-nitrophenyl)-9H-fluorene, and 100 mL tetrahydrofuran were charged. To the mixture, 56.1 mg (0.5 mmol) potassium tert-butoxide was charged. The mixture was stirred in air for 16 hours and the dark blue color disappeared. To the mixture, 0.189 g (5.0 mmol) sodium borohydride and 10 mL were charged. The mixture was stirred for additional 3 hours. The mixture was then poured into 200 mL water. The mixture was extracted with ethyl acetate for three times. The combined ethyl acetate layer was washed with deionized water for three times, then, dried over anhydrous sodium sulfate. After ethyl acetate was removed, the crude product was obtained as brownish yellow solids. The crude was further purified by recrystallization from toluene/heptane mixture. 12.3 grams of product was obtained, 81.1% isolate yield, m.p. 157.4-159.6° C. ¹H NMR (400 MHZ, CDCl₃) δ=8.09-8.11 (d, J=8.8 Hz, 2H), 7.69-7.71 (d, J=7.6 Hz, 2H), 7.51-7.53 (d, J=8.8 Hz, 2H), 7.38-7.43 (m, 2H), 7.26-7.27 (m, 4H), 2.55 (s, 1H). ¹³C NMR (101 MHz, CDCl₃) δ 150.80, 149.40, 147.09, 139.54, 129.70, 128.75, 126.42, 124.65, 123.50, 120.40, 83.32.

### Example 3 Synthesis of 4-(9-(4-aminophenyl)-9H-fluoren-9-yl)-2-fluoroaniline (FDA-AF1)

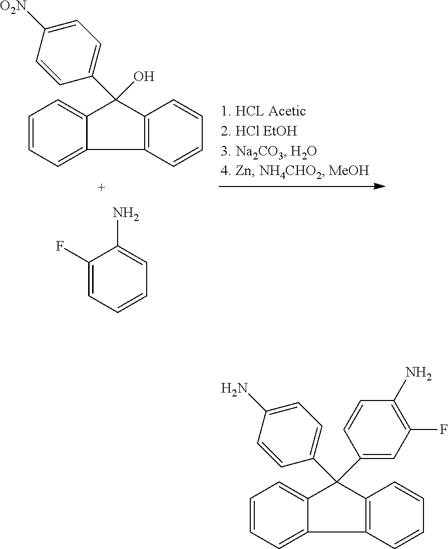 [SMILES: O=[N+]([O-])c1ccc(C2(O)c3ccccc3-c3ccccc32)cc1 ; Nc1ccccc1F ; Nc1ccc(C2(c3ccc(N)c(F)c3)c3ccccc3-c3ccccc32)cc1]

To a 100 mL round bottom flask equipped with magnetic stir bar, condenser, 6.07 g (20.0 mmol) 9-(4-nitrophenyl)-9H-fluoren-9-ol, 4.44 g (40.0 mmol) 2-fluoroaniline and 20 mL acetic acid were charged. To the mixture, 2.0 g 37% hydrochloric acid was charged slowly. Then, the mixture was heated to 120° C. in a pre-heated oil bath and held for 120° C. for 16 hours. After cooled to room temperature, the mixture was poured into 200 mL water. Solids were harvested via filtration, air convection dried. To a 300 mL round bottom flask equipped with magnetic stir bar, condenser, the crude product mentioned above, 31 mL 37% hydrochloric acid, 30 mL water and 60 mL ethanol were charged. The mixture was heated to reflux and held for 24 hours. After cooled to room temperature, ethanol was removed under reduced pressure, the solids were harvested via filtration. The solids were washed with 5% sodium carbonate solution, then de-ionized water, air dried. The crude product contained 4-(9-(4-nitrophenyl)-9H-fluoren-9-yl)-2-fluoroaniline and was used without further purification. To a 300 mL three necked round bottom flask equipped with magnetic stir bar, nitrogen inlet and outlet, the above crude product and 12.6 g (0.2 mol) ammonium formate were charged. After vacuum-back-filled with nitrogen for three times 150 mL and 6.54 g (0.1 mol) zinc powder were charged. The mixture was stirred at room temperature under nitrogen for 16 hours. Methanol was removed under reduced pressure to give yellow solids. The solids were extracted with 100 mL ethyl acetate for five times. The ethyl acetate phase was washed with de-ionized water, then, dried over sodium sulfate. After ethyl acetate was removed under reduced pressure, the crude product was obtained as light-yellow solids. The crude product was further purified by silica gel chromatography, a mixture of methylene chloride ethyl acetate (3:1 v/v) as eluent, the first major product was isolate as desired product. After column chromatography, the final product was further purified by recrystallized in toluene. The final product was obtained as pale-yellow crystals, 4.0 grams of product was obtained, 54.6% isolated over all yield, m.p. 248.3.5-249.5° C. ¹H NMR (400 MHZ, CDCl₃) δ=7.71-7.74 (dt, J=0.8, 7.6 Hz, 2H), 7.31-7.37 (m, 4H), 7.23-7.27 (m, 2H), 6.90-6.98 (d, J=8.4 Hz, 2H), 6.81-6.84 (dd, J=2.0, 12.8 Hz, 1H), 6.76-6.77 (dd, J=2.0, 8.0 Hz, 1H), 6.58-6.64 (dd, J=8.0, 9.4 Hz, 1H), 6.52-6.54 (d J=8.4 Hz, 2H), 3.59 (s, 2H), 3.56 (s, 2H). ¹³C NMR (101 MHz, CDCl₃) δ=152.40, 151.70, 150.04, 144.96, 139.89, 137.15, 137.10, 135.48, 132.81, 132.68, 129.02, 127.62, 127.25, 125.92, 124.09, 124.06, 120.06, 116.47, 116.43, 115.30, 115.10, 114.88, 63.98. ¹⁹F NMR (377 MHz, CDCl₃) δ=−134.73. HRMS (ESI): m/z calcd for C₂₅H₂₀FN₂⁺ [M+H]⁺ 367.1610, Found 367.1605.

### Example 4 Synthesis of 4-(9-(4-aminophenyl)-9H-fluoren-9-yl)-2-(trifluoromethyl) aniline (FDA-AF2)

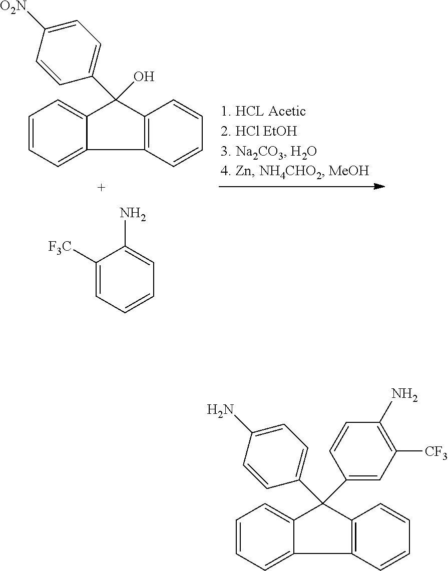 [SMILES: O=[N+]([O-])c1ccc(C2(O)c3ccccc3-c3ccccc32)cc1 ; Nc1ccccc1C(F)(F)F ; Nc1ccc(C2(c3ccc(N)c(C(F)(F)F)c3)c3ccccc3-c3ccccc32)cc1]

To a 100 mL round bottom flask equipped with magnetic stir bar, condenser, 8.19 (27.0 mmol) 9-(4-nitrophenyl)-9H-fluoren-9-ol, 8.70 g (54.0 mmol) 2-(trifluoromethyl) aniline and 30 mL acetic acid were charged. To the mixture, 2.7 g 37% hydrochloric acid was charged slowly. Then, the mixture was heated to 120° C. and held for 120° C. for 16 hours. After cooled to room temperature, the mixture was poured into 200 mL water. Solids were harvested via filtration, air convection dried. To a 300 mL round bottom flask equipped with magnetic stir bar, condenser, the crude product mentioned above, 31 mL 37% hydrochloric acid, 30 mL water and 100 mL ethanol were charged. The mixture was heated to reflux and held for 24 hours. After cooled to room temperature, ethanol was removed under reduced pressure, the solids were harvested via filtration. The solids were washed with 5% sodium carbonated solution, then de-ionized water, air dried. The crude product contained 4-(9-(4-nitrophenyl)-9H-fluoren-9-yl)-2-(trifluoromethyl) aniline and was used without further purification. To a 300 mL three necked round bottom flask equipped with magnetic stir bar, nitrogen inlet and outlet, the above crude product and 20.2 g (0.32 mol) ammonium formate were charged. After vacuum-back-filled with nitrogen for three times 150 mL and 10.45 g (0.16 mol) zinc powder were charged. The mixture was stirred at room temperature under nitrogen for 16 hours. Methanol was removed under reduced pressure to give yellow solids. The solids were extracted with 100 mL ethyl acetate for five times. The ethyl acetate phase was washed with de-ionized water, then, dried over sodium sulfate. After ethyl acetate was removed under reduced pressure, the crude product was obtained as light-yellow solids. The crude product was further purified by silica gel chromatography, methylene chloride as eluent, the first major product was isolate as desired product. After column chromatography, the final product was further purified by recrystallized in toluene. The final product was obtained as pale-yellow crystals, 3.5 grams of product was obtained, 31% isolated over all yield, m.p. 217.73.5-219.0° C. ¹H NMR (400 MHZ, CDCl₃) δ=7.72-7.73 (m, 2H), 7.30-7.34 (m, 4H), 7.22-7.26 (m, 3H), 7.11-7.14 (dd, J=8.8 Hz, 2H), 6.92-6.94 (d, J=8.4 Hz, 1H), 6.53-6.55 (d, J=8.8 Hz, 1H), 6.49-6.51 (d J=8.8 Hz, 2H), 4.01 (s, 2H), 3.53 (s, 2H). ¹³C NMR (101 MHz, CDCl₃) δ=151.52, 145.00, 142.97, 142.95, 142.93, 142.91, 139.90, 135.54, 135.34, 132.81, 128.95, 128.91, 127.69, 127.35, 126.24, 125.81, 125.75, 125.69, 125.64, 123.53, 120.83, 120.13, 117.13, 114.96, 113.72, 113.42, 113.13, 112.83, 63.83. ¹⁹F NMR (377 MHz, CDCl₃) δ=−62.43. HRMS (ESI): m/z calcd C₂₆H₂₀F₃N₂⁺[M+H]⁺ 417.1578, Found 417.1573.

### Example 5 Synthesis of polyimide 6FDA-FDA-AF1

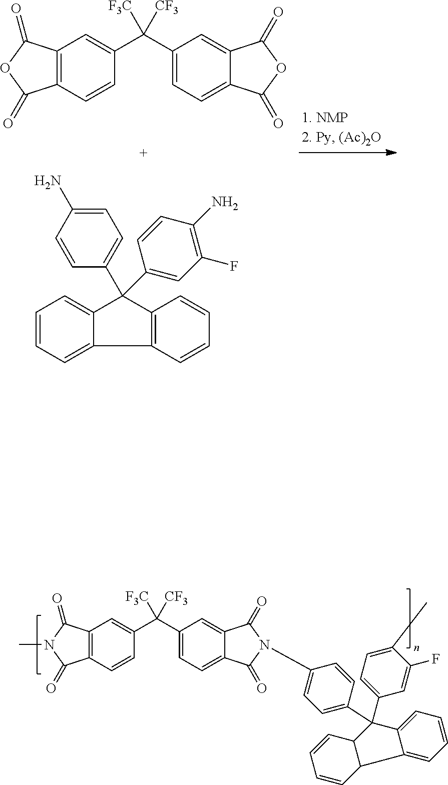

To a 100 mL round bottom flask equipped with stir bar and nitrogen inlet, 1.0985 g (3.000 mmol) of FDA-AF1 and 11.5 mL anhydrous were charged. The mixture was stirred under nitrogen until all FDA-F₁ was dissolved in NMP. To the mixture, 1.3327 g (3.000 mmol) 6FDA was added. The mixture was stirred at room temperature for 18 hours. Then, to the mixture, 3 mL anhydrous pyridine and 3.6 mL acetic acid anhydride were charged. After the mixture stirred at room temperature for additional 18 hours. The mixture was poured slowly into 200 mL 2-propanol. Solids were harvested via filtration as polyimide. The polyimide was air convection dried, and further dried under 0.5 torr vacuum at 160° C. for 24 hours. The glass transition of polyimide 6FDA-FDA-AF1 was determined by DSC as 386° C. The polyimide 6FDA-FDA-AF1 was soluble in methyl ethyl ketone, but only swollen in ethyl acetate.

### Example 6 Synthesis of homo-polyimide, 6FDA-FDA-AF2

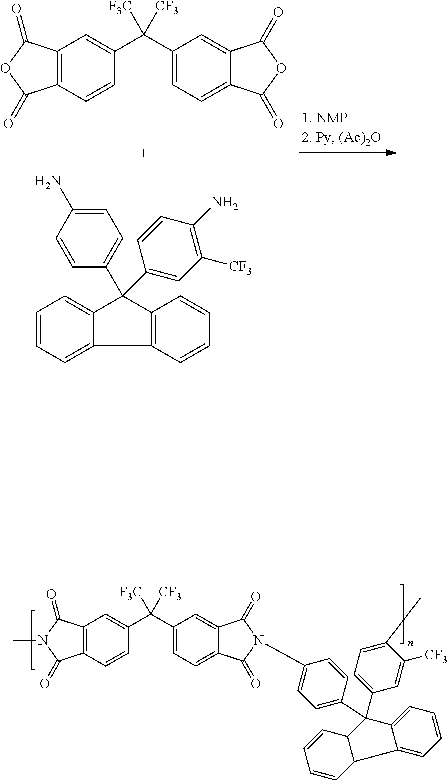

To a 100 mL round bottom flask equipped with stir bar and nitrogen inlet, 0.8329 g (2.000 mmol) of FDA-AF2 and 8 mL anhydrous were charged. The mixture was stirred under nitrogen until all FDA-AF2 was dissolved in NMP. To the mixture, 0.8885 g (2.000 mmol) 6FDA was added. The mixture was stirred at room temperature for 18 hours. Then, to the mixture, 2 mL anhydrous pyridine and 2.4 mL acetic acid anhydride were charged. After the mixture stirred at room temperature for additional 18 hours. The mixture was poured slowly into 200 mL 2-propanol. Solids were harvested via filtration as polyimide. The polyimide was air convection dried, and further dried under 0.5 torr vacuum at 160° C. for 24 hours. The glass transition of polyimide 6FDA-FDA-AF2 was determined by DSC as 341° C. The polyimide 6FDA-FDA-AF2 was soluble in methyl ethyl ketone and ethyl acetate.

Example 6 Preparation of composite of gold spheric nanoparticles with polyimide (6FDA-FDA-AF2) by method 3 and reconfigure the composite to a thin film To a 0.1 grams of polyimide 6FDA-FDA-AF2 in 10 mL tetrahydrofuran (THF) solution, 1.0 mL gold nano spheric particles solution is charged, the plasmonic absorption peak at 523 nm The precipitation was harvested, via filtration, then air convection dried. The composite is resolved in 4 mL THF solution, then cast onto a 2″×2″ glass slide inside an oven to control THF evaporation rate. After drying at room temperature for 2 days and further vacuum drying for additional two days. The composite film is peeled off from glass slide to give a free-standing thin film with average thickness about 30 micrometers.

### Example 7 Synthesis of Co-Polyimide Using a Mixture of ODPA and 6FDA as the Anhydride (ODPA-FDA-F-co-6FDA-FDA-AF1)

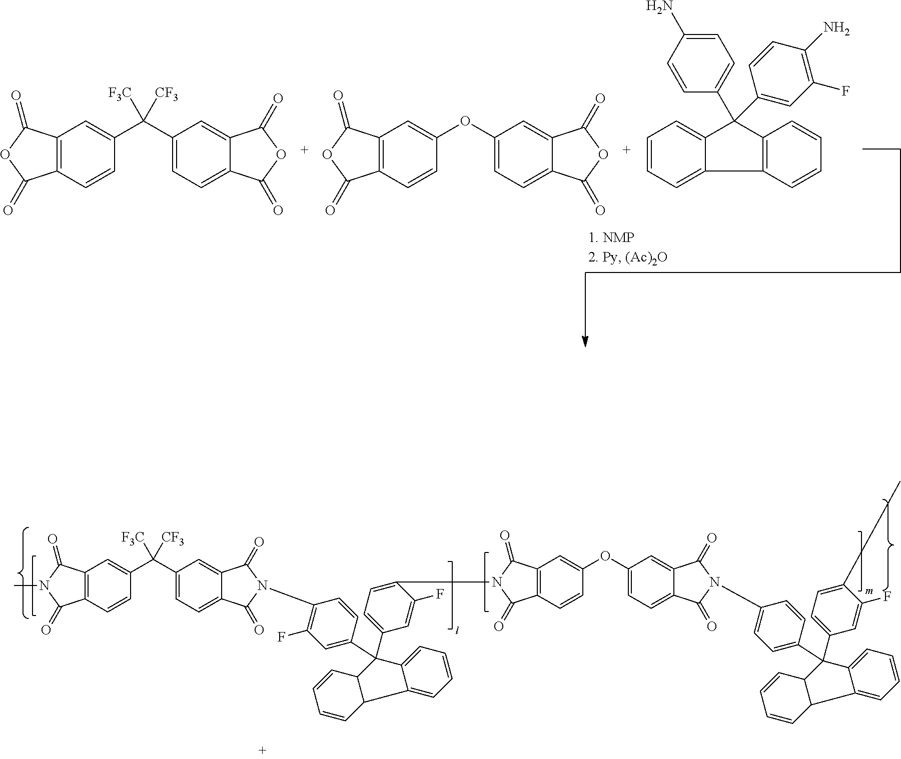

To a 100 mL round bottom flask equipped with stir bar and nitrogen inlet, 1.4658 g (4.000 mmol) of FDA-AF1 and 15 mL anhydrous are charged. The mixture is stirred under nitrogen until all FDA-F is dissolved in NMP. To the mixture, 0.6204 g (2.000 mmol) ODPA, and 0.8885 (2.000 mmol) 6FDA are charged. The mixture is stirred at room temperature for 18 hours. Then, to the mixture, 0.8 mL anhydrous pyridine and 0.9 mL acetic anhydride are charged. The mixture is heated to 80° C. and held for 6 hours. After cooled to room temperature, the mixture is poured slowly into 600 mL 2-propanol. Solids are harvested via filtration as polyimide. The polyimide was air convectional dried, and further dried under 0.5 torr vacuum at 160° C. for 24 hours.

### Example 8 Synthesis of Co-Polyimide 6FDA as the Anhydride Using Mixture of FDA and FDA-AFa Mixture as the Diamine, 6FDA-FDA-Co-6FDA-FDA-AF1

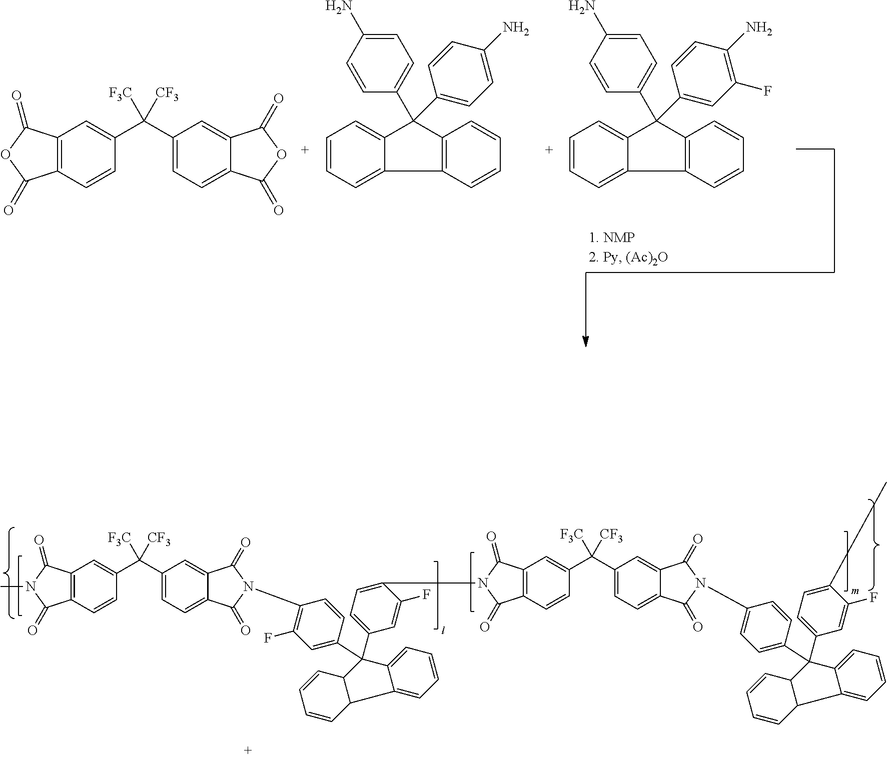

To a 100 mL round bottom flask equipped with stir bar and nitrogen inlet, 0.7329 g (2.000 mmol) of FDA-AF1, 0.6969 g (2.000 mmol) FDA and 12 mL anhydrous are charged. The mixture was stirred under nitrogen until all diamines were dissolved in NMP. To the mixture, 1.7770 (4.000 mmol) 6FDA are charged. The mixture is stirred at room temperature for 18 hours. Then, to the mixture, 0.8 mL anhydrous pyridine and 0.9 mL acetic anhydride are charged. The mixture is heated to 80° C. and held for 6 hours. After cooled to room temperature, the mixture is poured slowly into 600 mL 2-propanol. Solids are harvested via filtration as polyimide. The polyimide is air convectional dried, and further dried under 0.5 torr vacuum at 160° C. for 24 hours.

What is claimed is:

1. A fluorene containing diamine monomer having one of the following structures: 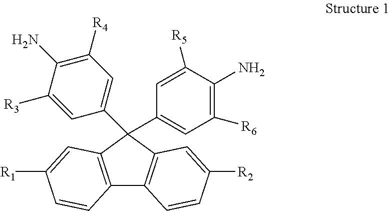
wherein for Structure 1, R₁, R₂, R₃, R₄, R₅ and R₆ are each independently H, CH₃, CF₃, F, Cl or Br, with the proviso that at least one of R₃, R₄, R₅, R₆ are not identical; 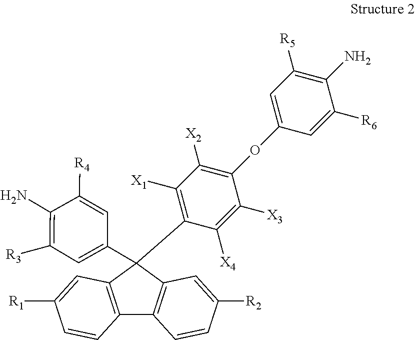
wherein for Structure 2: R₁, R₂, R₃, R₄, R₅, R₆, X₁, X₂, X₃, and X₄ are each independently H, CH₃, CF₃, F, Cl or Br, with the proviso that at least one of R₃, R₄, R₅, R₆, X₁, X₂, X₃, X₄ are not identical; 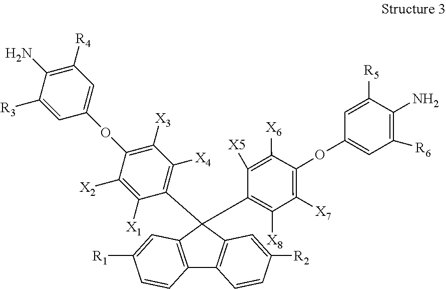
wherein for Structure 3: R₁, R₂, R₃, R₄, R₅, R₆, X₁, X₂, X₃, X₄, X₅, X₆, X₇ and X₈ are each independently H, CH₃, CF₃, F, Cl or Br, with the proviso that at least one of R₃, R₄, R₅, R₆, X₁, X₂, X₃, X₄, X₅, X₆, X₇ and X₈ are not identical.

2. A diamine monomer according to claim 1, said diamine monomer having Structure 1: wherein for said Structure 1: R₁, R₂, R₃, R₄, R₅ and R₆ are each independently H, CH₃, CF₃, F, Cl or Br, with the proviso that at least one of R₃, R₄, R₅, R₆ are not identical.

3. A process of making a diamine monomer, said process comprising:
a.) combining, under an inert atmosphere, a polar aprotic solvent and a first molecule having structure of Formula 1 and a second molecule having structure of Formula 2 or Formula 3 below to form the first mixture, said first molecule and said second molecule being combined in a molar ratio from about 1:0.5 to about 1:2; 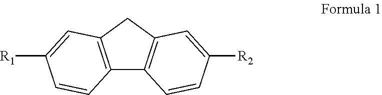
wherein for Formula 1, R₁, and R₂ are each independently H, CH₃, CF₃, F, Cl or Br; preferably for Formula 1 R₁, and R₂, are each independently CF₃ or F; and the second molecule having structure of Formula 2 or Formula 3 below: 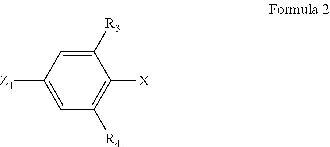
wherein for Formula 2, R₃ and R₄, are each independently H, CH₃, CF₃, F, Cl or Br; Z₁ is H, NO₂ or F; and X is an amino, nitro or acetamido group; 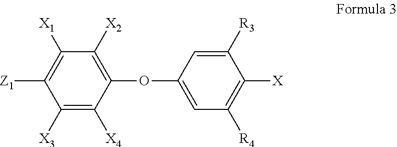
wherein Formula 3, R₃, R₄, X₁, X₂, X₃ and X₄, are each independently H, CH₃, CF₃, F, Cl or Br; Z₁ is H, NO₂, F; X is an amino, nitro or acetamido group; to form a first mixture;
b.) adding a base to said first mixture to form a second mixture, said base being added to said first mixture in a molar ratio of base to the said first molecule in said first mixture of from about 1:1 to about 5:1;
c.) stirring said second mixture for about 1 hour to about 24 hours under an inert atmosphere;
d.) adding an acid to said second mixture to yield a third molecule having Formula 4 or Formula 5 below 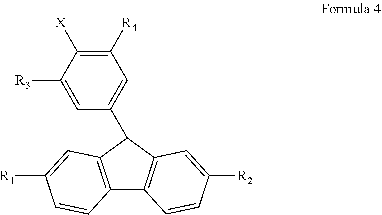
wherein Formula 4, R₃ and R₄ are each independently H, CH₃, CF₃, F, Cl or Br; X is an amino, nitro or acetamido group; 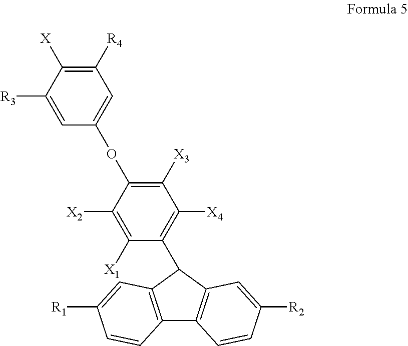
wherein for Formula 5, R₃, R₄, X₁, X₂, X₃, and X₄ are each independently H, CH₃, CF₃, F, Cl or Br; X is an amino, nitro or acetamido group;
e) oxidizing said third molecule to yield a fourth molecule, said fourth molecule having Formula 6 or Formula 7 below: 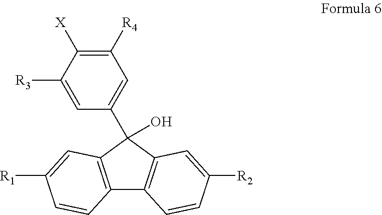
wherein Formula 6, R₃ and R₄ are each independently H, CH₃, CF₃, F, Cl or Br; X is an amino, nitro or acetamido group. preferably R₃ and R₄ are each independently is H, CF₃ or F; 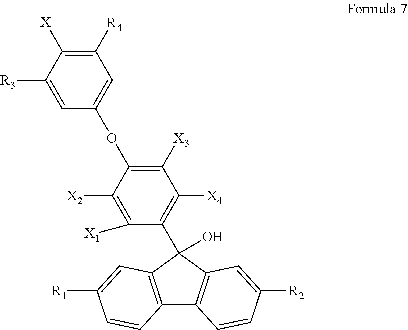
wherein for Formula 7, R₃, R₄, X₁, X₂, X₃ and X₄ are each independently H, CH₃, CF₃, F, Cl or Br; X is an amino, nitro or acetamido group, preferably R₃, R₄, X₁, X₂, X₃ and X₄ are each independently is H, CF₃ or F;
f) combing said second molecule, an acid, said fourth molecule and a solvent, to form a fourth mixture, heating said fourth mixture to a temperature of about 40° C. to about 150° C. and holding said fourth mixture at said temperature for 1 to 48 hours to yield a fifth molecule, said fifth molecule having Formula 8, 9 or 10 below: 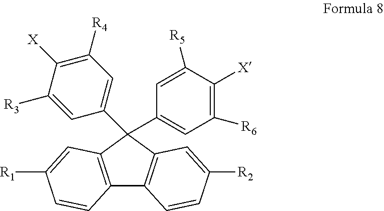
wherein for Formula 11, R₁, R₂, R₃, R₄, R₅ and R₆ are each independently H, CH₃, CF₃, F, Cl or Br; X and X′ are each independently an amino, nitro or acetamido group; 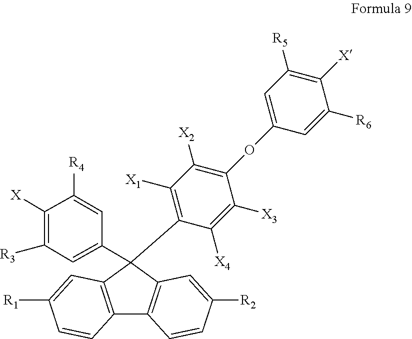
wherein for Formula 12: R₁, R₂, R₃, R₄, R₅, R₆, X₁, X₂, X₃ and X₄ are each independently H, CH₃, CF₃, F, Cl or Br, X and X′ are each independently an amino, nitro or acetamido group; 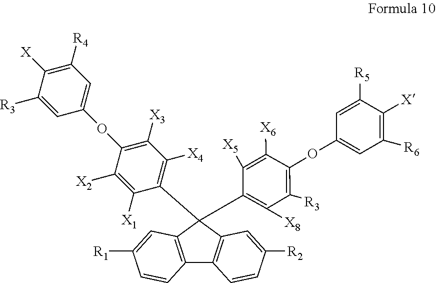
wherein for Formula 13: R₁, R₂, R₃, R₄, R₅, R₆, X₁, X₂, X₃, X₄, X₅, X₆, X₇, and X₈ are each independently H, CH₃, CF₃, F, Cl or Br, and X and X′ are each independently an amino, nitro or acetamido group; and
g) when for said fifth molecule, X and/or X′ are not amino groups, said X and/or X′ are converted into amino groups by reducing any of X and X′ that is a nitro group and by hydrolyzing any X or X′ that is an acetamido groups.

4. A polyimide polymer comprising a monomer according to claim 1 with one or more first diamine monomers having structures 1, 2 and/or 3 below: 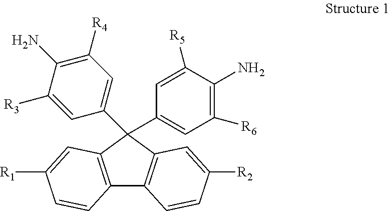
wherein for Structure 1: R₁, R₂, R₃, R₄, R₅ R₆ are each independently is H, CH₃, CF₃, F, Cl or Br, with the proviso that at least one of R₃, R₄, R₅, R₆ are not identical; 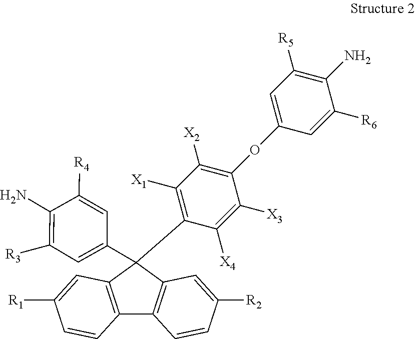
wherein for Structure 2: R₁, R₂, R₃, R₄, R₅, R₆, X₁, X₂, X₃ and X₄ are each independently is H, CH₃, CF₃, F, Cl or Br, with the proviso that at least one of R₃, R₄, R₅, R₆, X₁, X₂, X₃, X₄ are not identical; 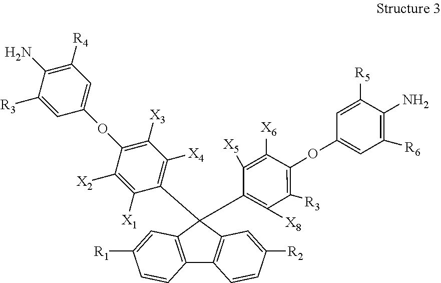
wherein for Structure 3: R₁, R₂, R₃, R₄, R₅, R₆, X₁, X₂, X₃, X₄, X₅, X₆, X₇ and X₈ are each independently H CH₃, CF₃, F, Cl or Br, with the proviso that at least one of R₃, R₄, R₅, R₆, X₁, X₂, X₃, X₄, X₅, X₆, X₇, X₈ are not identical,
and at least one optional second diamine monomers having a structure that is different from said Structures 1, 2 and 3.

5. A process of making the polyimide polymer of claim 4, said process comprising reacting via a condensation reaction a first diamine monomer, said first diamine monomer being a diamine monomer according to claim 1 and/or claim 2 with one or more dianhydrides and one or more optional second diamine monomers.

6. The process of claim 5 wherein said one or more dianhydrides are selected from the group consisting of dianhydrides having the structures below and mixtures thereof

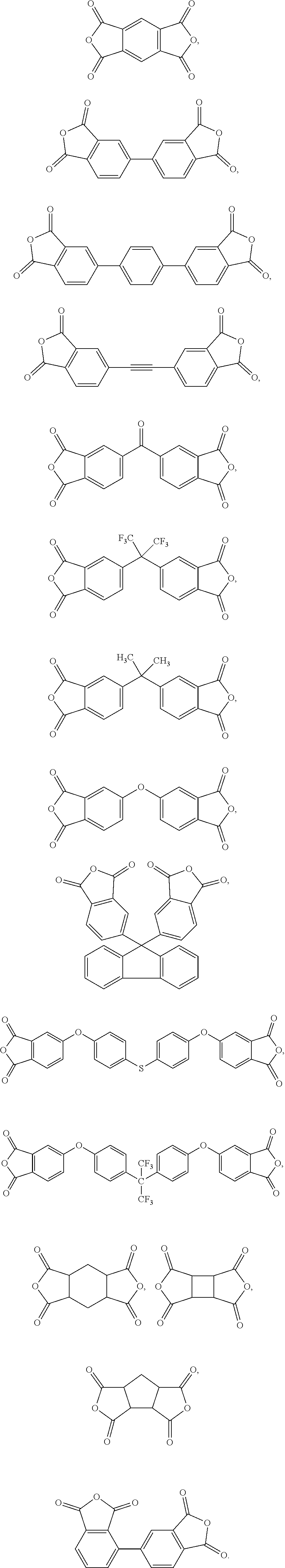

7. The process of making a polyimide polymer according to claim 5 wherein said first diamine monomer has Structure 1 and/or Structure 2 of claim 1.

8. The process of making a polyimide polymer according to claim 6 wherein the molar ratio of said second diamine to said first diamine is from about 0.005:1 to about 2.0:1.

9. The process of making a polyimide polymer according to claim 5 wherein the molar ratio of total diamines to said total dianhydrides is from about 0.95:1 to about 1:0.95.

10. An article comprising a polyimide according to claim 4.

11. A composition comprising one or more solvents, a polyimide polymer according to claim 4 and one or more optional adjuncts, said composition being a coating, an adhesive or a prepreg solution.

12. The composition of claim 11, wherein said polyimide polymer comprise one or more functional groups.

13. The composition of claim 11 wherein said polyimide polymer has a weight percentage of repeat units, based on total polyimide polymer, of from about 40% to about 99%.

14. The composition of claim 11 wherein said polyimide polymer comprises one or more functional groups selected from the group consisting of a hydroxy moiety, a vinyl moiety, an acrylic moiety, a methacrylic moiety, an epoxy moiety, a phenylethynyl moiety and mixtures thereof, said functional groups being present in said polyimide polymer, based on total polyimide polymer weight, in a range of from about 0.5% to about 60%.

15. The composition of claim 11 said composition having a polyimide solid content, based on total composition weight, of from about 0.5% to about 50%.

16. The composition of claim 11 comprising an adjunct material, said adjunct material comprising a reinforcing filler, a dye, a pigment, a photo radical initiator, a thermal initiator, photo cationic initiator salt, photo anionic initiator salt, and/or an inorganic salt.

17. The composition of claim 16 wherein said reinforcing filler comprises chopped carbon fiber, carbon fiber fabric, chopped glass fiber, glass fiber fabric, metal oxide particulates, metal particulates and/or nano particles.

18. The composition of claim 16 wherein said photo radical initiator is selected from the group consisting of 2,4,6-trimethylbenzoyldiphenylphosphine oxide; bis(2,4,6-trimethylbenzoyl)phenylphosphine oxide; bis(2-ethylhexyl)phosphine oxide; phenyl[bis(2-phenylethyl)]phosphine oxide and mixtures thereof.

19. The composition of claim 16 wherein said thermal initiator is selected from the group consisting of azobisisobutyronitrile; benzoyl peroxide; 2,2-bis(tert-butylperoxy) butane; 1,1-bis(tert-butylperoxy)-3,3,5-trimethylcyclohexane; tert-butyl hydroperoxide; 2,4-pentanedione peroxide; 2,5-bis(tert-butylperoxy)-2,5-dimethylhexane and mixtures thereof.

20. The composition of claim 16 wherein said inorganic salt is selected from the group consisting of iron(III) chloride, nickel chloride, copper(II) chloride, cobalt(III) chloride, iron (III) bromide, nickel bromide, cobalt(III) bromide, palladium chloride, palladium acetate and mixtures thereof.

21. The composition of claim 16 wherein said cationic photo initiator salt is selected from the group consisting of bis(4-tert-butylphenyl) iodonium hexafluorophosphate, 2-(1,3-benzodioxol-5-yl)-4,6-bis(trichloromethyl)-1,3,5-triazine, bis(4-tert-butylphenyl) iodonium tetrafluoroborate, bis[4-(tert-butyl)phenyl]iodonium tetra(nonafluoro-tert-butoxy)aluminate, bis(4-tert-butylphenyl) iodonium nonafluoro-1-butanesulfonate, bis(4-tert-butylphenyl) iodonium hexafluoroantimonate, bis(4-tert-butylphenyl) iodonium chloride, diphenyliodonium hexafluoroarsenate, nitrobenzenediazonium tetrafluoroborate, cyclopentadienyliron(ii) hexafluorophosphate, and mixtures thereof.

22. The composition of claim 16 wherein said anionic photo imitator salt is selected from the group consisting of 2-(9-oxoxanthen-2-yl) propionic acid 1,5,7-triazabicyclo[4.4.0]dec-5-ene salt, 2-(9-oxoxanthen-2-yl) propionic acid 1,5-diazabicyclo[4.3.0]non-5-ene salt, 2-(9-oxoxanthen-2-yl) propionic acid 1,8-diazabicyclo[5.4.0]undec-7-ene salt, and mixtures thereof.

23. An article comprising a composition according to claim 11.

24. An automobile, ship, rocket, airplane, spacecraft or satellite comprising the article of claim 23.
